(19) United States
(12) Patent Application Publication
(10) Pub. No.: US 2002/0039263 A1
(43) Pub. Date: Apr. 4, 2002

(54) MAGNETIC HEAD , AND METHOD OF MANUFACTURING SAME

(76) Inventor: TERUO INAGUMA, MIYAGI (JP)

Correspondence Address: DAVID R. METZGER, ESQ., SONNENSCHEIN NATH & ROSENTHAL, P.O. BOX #061080, WACKER DRIVE STATIONS, SEARS TOWER, CHICAGO, IL, 60606-1080, US

(21) Appl. No.: 09/215,317

(22) Filed: Dec. 18, 1998

(30) Foreign Application Priority Data
Dec. 25, 1997 (JP) PO9-358205

(51) Int. Cl. G11B 5/127; G11B 5/39

(52) U.S. Cl. 360/322; 360/125

(57) ABSTRACT

A magnetic head having connecting terminals that can be easily connected to terminals of a support base using an automatic wiring machine, and a method of manufacturing the magnetic head with an improved productivity.

Conductor portions are provided on, and projected from, the joint face of the pair of core blocks (2, 3). The conductor portions are cut in the direction of their thickness and the resulted cut surfaces are used as the connecting terminals (17, 18).

### BACKGROUND OF THE INVENTION

1. Field of the Invention

The present invention relates to a magnetic head for recording and/or reproducing a signal into and/or from a magnetic recording medium, and a method of manufacturing the magnetic head.

2. Description of Related Art

A recording and reproducing method, called “helical scan”, has been proposed in which a magnetic head installed on a rotating drum slides helically on a passing magnetic tape to write or read a predetermined data into, or a recorded data from, the magnetic tape.

Since a data is recorded or reproduced by a magnetic head sliding on a passing magnetic tape at a high speed, so the helical scan is advantageous in that the speed of the sliding of the magnetic head in relation to the magnetic tape is advantageously high and thus a high rate of data transfer is attainable.

Normally, the magnetic head used for the helical scan is attached to a support base and the support base with the magnetic head is installed on a rotating drum.

In case the magnetic head is of a magnetic induction type using a coil, it is provided with a connecting terminals to supply the coil with a current. If magnetic head is of a magnetoresistance (MR) effect type using a magnetoresistive element (will be referred to as “MR element” hereinunder) whose resistance varies depending upon a change of the external magnetic field, it is provided with connecting terminals to supply the MR element with a current. With the connecting terminals of the magnetic head are connected to terminals connected to a power source provided on the support base, the coil or MR element is supplied with the current.

Referring now to FIG. 1, there is illustrated a conventional magnetic head generally indicated with a reference 100. The magnetic head 100 comprises a pair of core blocks 101 and 102 and a connecting terminal block 103 formed on one side face 101a of one (101 in this case) of these core blocks at which the core block 101 is joined integrally to the other core block 102. That is, in the conventional magnetic head 100, one (101) of the core blocks 101 and 102 has a side face at which the core block 101 is joined integrally to the other core block 102 and which is larger in area than a side face of the other core block 102 that faces the side face of the core block 101. Namely, when the core blocks 101 and 102 in pair are joined integrally to each other, a part of the side face 101a of the core block 101 is exposed and the terminal block 103 is disposed on the exposed part of the side face 101a.

The magnetic head 100 is installed at a rear face 100a thereof, not parallel to the side face 101a of one of the core blocks (101), on a main surface 10a of a support base 110 on which terminals 111 and 112 are provided.

In effect, when the magnetic head 100 is installed on the support base 110, the side face 101a of the magnetic head 100 at which the terminal block 103 is disposed is not parallel to the main surface 110a of the support base 110 on which the terminals 111 and 112 are disposed.

Thus, the terminal block 103 of the magnetic head 100 and the terminals 111 and 112 of the support base 110 have to be connected to each other by hand using flexible conductor sheets 113 and 114 or the like since the terminal block 103 and terminals 111 and 112 are disposed on the planes, respectively, not parallel to each other. Therefore, a wire-bonding machine or the like used in manufacture of semiconductor devices, etc. cannot be used to automatically connect the terminals to each other, which leads to a very poor productivity.

### SUMMARY OF THE INVENTION

Accordingly, the present invention has an object to overcome the above-mentioned drawbacks of the prior art by providing a magnetic head and a method of manufacturing the magnetic head, in which an automatic connection between connecting terminals of the magnetic head and terminals of a support base can be attained using an automatic wiring machine, which contributes greatly to an increased productivity.

The above object can be attained by providing a magnetic head comprising, according to the present invention, a pair of core blocks joined integrally to each other, and conductor portions disposed on, and projecting from, a face of at least one of the core blocks, not parallel to a face of the core block at which the core block is joined to a support base. In this magnetic head, end faces of the conductor portions, obtained by cutting the conductor portions in the direction of their thickness, are exposed on the face of the core block at which the core block is joined to the support base or on a face of the core block generally parallel to the face at which the core block is joined to the support base, and are used as connecting terminals for connection to terminals of the support block.

In this magnetic head, since the connecting terminals are disposed on the face of the core block at which the core block is joined to the support base or a face of the core block generally parallel to the face at which the core block is joined to the support base, an automatic wiring machine can be used to automatically connect them to the terminals provided on the support base.

The above object can also be attained by providing a method of manufacturing the magnetic head according to the present invention, comprising a first step of forming projecting conductor portions on a face of at least one of the core blocks joined integrally to each other, not parallel to a face of the core block at which the core block is joined to the support base, and a second step of cutting the conductor portions in the direction of their thickness to have the cut end faces of the conductor portions exposed on the face of the core block at which the core block is joined to the support base or a face of the core block generally parallel to the face of the core block at which the core block is joined to the support base, the exposed end faces of the conductor portions being used as connecting terminals for connection to the terminals of the support base.

The method of manufacturing the magnetic head permits to produce a magnetic head having the connecting terminals disposed on the face of the core block at which the core block is joined to the support base or a face of the core block generally parallel to the face at which the core block is joined to the support base, by using a wiring machine to automatically connect the connecting terminals of the terminals provided on the support base.

### BRIEF DESCRIPTION OF THE DRAWINGS

These objects and other objects, features and advantages of the present intention will become more apparent from the following detailed description of the present invention when taken in conjunction with the accompanying drawings, of which:

FIG. 1 is a perspective view of a conventional magnetic head supported on a support base;

FIG. 2 is a plan view of an MR head according to the present invention;

FIG. 3 is a sectional view taken along the line A-A in FIG. 1;

FIG. 4 is a sectional view taken along the line B-B in FIG. 1;

FIG. 5 is a plan view of the MR head supported on the support base;

FIG. 6 is an explanatory drawing of the MR manufacturing process;

FIG. 7 is a perspective view of the substrate just prepared in the MR head manufacturing process;

FIG. 8 is a sectional view of an essential portion of the substrate on which a first nonmagnetic, nonconductive layer is formed in the MR head manufacturing process;

FIG. 9 is a sectional view of the essential portion of the substrate on which layers are further laminated in the MR head manufacturing process;

FIG. 10 is a plan view of the essential portion of the substrate on which ferromagnetic layers are formed in the MR head manufacturing process;

FIG. 11 is a plan view of the essential portion of the substrate on which conductor portions are further formed in the MR head manufacturing process;

FIG. 12 is a plan view of the essential portion of the substrate on which a photoresist is applied in the MR head manufacturing process;

FIG. 13 is a sectional view taken along the line C-C in FIG. 11, showing also the MR head manufacturing process;

FIG. 14 is a sectional view of the essential portion of the substrate on which a film metallic film is further formed in the MR head manufacturing process;

FIG. 15 is a sectional view of the essential portion of the substrate on which a thick photoresist layer is further applied in the MR head manufacturing process;

FIG. 16 is a sectional view of the essential portion of the substrate on which conductors are provided in the MR head manufacturing process;

FIG. 17 is a sectional view of the essential portion of the substrate from which the thick photoresist layer has been removed in the MR head manufacturing process;

FIG. 18 is a sectional view of the essential portion of the substrate on which a second nonmagnetic, nonconductive layer is formed in the MR head manufacturing process;

FIG. 19 is a plan view of the essential portion of the finished substrate which is to be cut in the MR head manufacturing process;

FIG. 20 is a plan view of the substrate to which core blocks are joined in the MR head manufacturing process;

FIG. 21 is a plan view of the substrate on which the conductor portions and conductors are covered with a protective material in the MR head manufacturing process;

FIG. 22 is a plan view of the substrate of which a surface on which a recording medium slides is formed in the MR head manufacturing process;

FIG. 23 is an overall perspective view of the bulk thin-film type magnetic head according to the present invention;

FIG. 24 is a perspective view, enlarged in scale, of the portion A of the bulk thin-film type magnetic head in FIG. 22;

FIG. 25 is an exploded perspective view of the bulk thin-film type magnetic head;

FIG. 26 is a plan view of the bulk thin-film type magnetic head supported on the support base;

FIG. 27 is en explanatory drawing of the bulk thin-film type magnetic head manufacturing process;

FIG. 28 is a perspective view of a pair of nonmagnetic substrates just prepared in the bulk thin-film type magnetic head manufacturing process;

FIG. 29 is a perspective view of the pair of nonmagnetic substrates on which magnetic core forming recesses are formed in the bulk thin-film type magnetic head manufacturing process;

FIG. 30 is a perspective view of the pair of nonmagnetic substrates on which magnetic metallic films are further formed in the bulk thin-film type magnetic head manufacturing process;

FIG. 31 is a perspective view of the pair of nonmagnetic substrates on which isolation and winding recesses are further formed in the bulk thin-film type magnetic head manufacturing process;

FIG. 32 is a perspective view of the pair of nonmagnetic substrates in which a low melting point glass is charged in the bulk thin-film type magnetic head manufacturing process;

FIG. 33 is a perspective view of the pair of nonmagnetic substrates in which concavities are formed in the bulk thin-film type magnetic head manufacturing process;

FIG. 34 is a perspective view of the pair of nonmagnetic substrates in which coil forming concavities are formed in the bulk thin-film type magnetic head manufacturing process;

FIG. 35 is a perspective view of the portion B in FIG. 32, showing the bulk thin-film type magnetic head manufacturing process;

FIG. 36 is a perspective view of the portion C in FIG. 32, showing the bulk thin-film type magnetic head manufacturing process;

FIG. 37 is a sectional view taken along the line D-D in FIG. 34, showing the bulk thin-film type magnetic head manufacturing process;

FIG. 38 is a sectional view of an essential portion of the nonmagnetic substrate on which a photoresist is applied in the bulk thin-film type magnetic head manufacturing process;

FIG. 39 is a sectional view of an essential portion of the nonmagnetic substrate on which a metallic film is further formed in the bulk thin-film type magnetic head manufacturing process;

FIG. 40 is a sectional view of an essential portion of the nonmagnetic substrate on which a thick photoresist layer is further applied in the bulk thin-film type magnetic head manufacturing process;

FIG. 41 is a sectional view of an essential portion of the nonmagnetic substrate on which conductors are further formed in the bulk thin-film type magnetic head manufacturing process;

FIG. 42 is a sectional view of an essential portion of the nonmagnetic substrate from which the thick photoresist layer has been removed in the bulk thin-film type magnetic head manufacturing process;

FIG. 43 is a perspective view of a pair of magnetic core half blocks in the bulk thin-film type magnetic head manufacturing process;

FIG. 44 is an explanatory drawing of a step at which the pair of magnetic core half blocks are joined to each other in the bulk thin-film type magnetic head manufacturing process; and

FIG. 45 is an explanatory drawing of a step at which the magnetic core block is cut in the bulk thin-film type magnetic head manufacturing process.

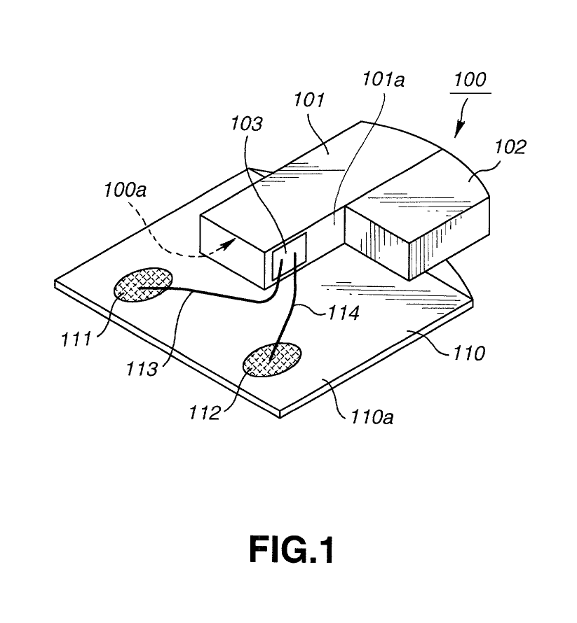

### DETAILED DESCRIPTION OF THE PREFERRED EMBODIMENTS

The present invention will be described first concerning a magnetoresistance effect type magnetic head (will be referred to as “MR head” hereinunder) using a magnetoresistive element (will be referred to as “MR element” hereinunder) whose resistance varies depending upon a change of the external magnetic field.

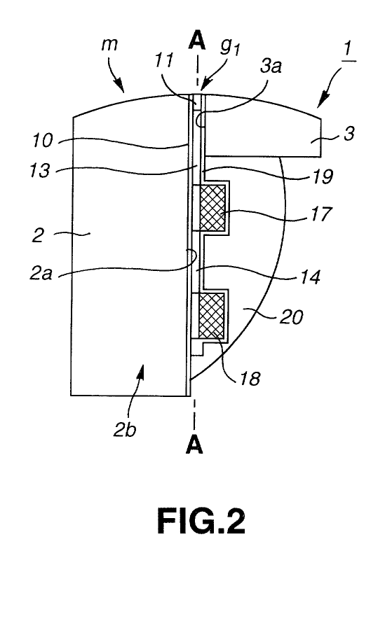

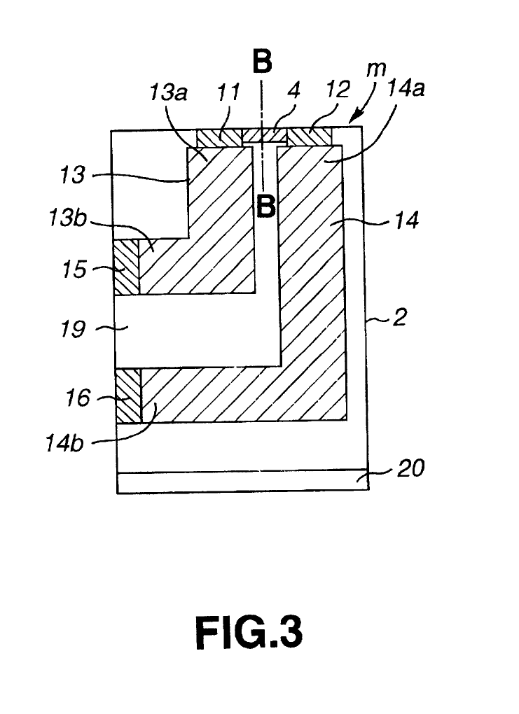

Referring now to FIGS. 2 and 3, there is illustrated an MR head generally indicated with a reference 1. The MR head 1 comprises first and second shield cores 2 and 3 formed from a soft magnetic material such as Ni—Zn ferrite and joined integrally to each other with a gap g₁ thus defined between them, and a magnetic sensor 4 provided in the gap g₁ and including an MR element and a soft adjacent layer (SAL) provided to apply the MR element with a DC bias magnetic field. In this MR head 1, the magnetic sensor 4 has an outwardly directed face m thereof polished and on which a magnetic recording medium slides past. Note that FIG. 3 is a sectional view of the first shield core 2 taken along the line A-A in FIG. 2.

The first shield core 2 has a face generally orthogonal to the medium sliding face m thereof and which becomes larger in area than the second shield core 3 in a direction away from the medium sliding face m. The second shield core 3 is joined to the medium sliding face m of the first shield core 2 with the gap g1 thus defined between the first and second shield cores 2 and 3.

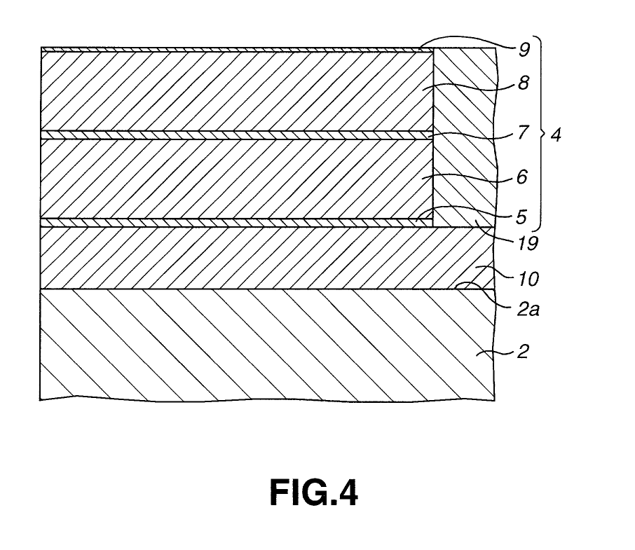

In the magnetic sensor 4, each of the MR element and SAL layer is sandwiched between thin nonmagnetic layers. The magnetic sensor 4 is disposed in the gap g, defined between the first and second shield cores 2 and 3. As shown in FIG. 4, the magnetic sensor 4 comprises a lamination of a first nonmagnetic layer 5 made of a nonmagnetic material such as Ta, SAL layer 6 made of a soft magnetic material such as NiFeNb, second nonmagnetic layer 7 made of a nonmagnetic material such as Ta, MR element 8 made of NiFe, for example, and a third nonmagnetic layer 9 made of a nonmagnetic material such as Ta, in this order from above. The magnetic sensor 4 thus constructed is stacked on a joint face 2a of the first shield core 2 with a first gap layer 10 formed between them. The first gap layer 10 is made of Al₂O₃, for example, and charged in the gap g₁.

When the first and second shield cores 2 and 3 are joined to each other, the magnetic sensor 4 is disposed in the gap g₁ defined between the joint faces 2a and 3a of the first and second shield cores 2 and 3, respectively. Note tat FIG. 4 is a sectional view taken along the line B-B in FIG. 3.

The magnetic sensor 4 has the form of a rectangular parallelepiped and is disposed inside the gap g₁ for its length to be generally parallel to the medium sliding face m. The length of the magnetic sensor 4 is the track width of the MR head 1.

Also, there is disposed inside the gap g₁ and adjacent to the opposite longitudinal ends of the magnetic sensor 4 a pair of ferromagnetic pieces 11 and 12 made of CoNiPt, for example, to simplify the magnetic domain of the magnetoresistive element 8. Similar to the magnetic sensor 4, the ferromagnetic pieces 11 and 12 are formed on the joint face 2a of the first shield core 2 on which the first gap layer 10 is also formed. Thus, when the first and second shield cores 2 and 3 are joined to each other, the ferromagnetic pieces 11 and 12 are disposed inside the gap g₁ defined between the joint faces 2a and 3a of the first and second shield cores 2 and 3, respectively.

A pair of conductors 13 and 14 made of Cu, for example, is provided on the joint face 2a of the first shield core 2 on which the first gap layer 10 is formed. The conductors 13 and 14 in pair are provided as electrodes to supply the MR element 8 with a sense current. They are connected at one ends 13a and 14a thereof connected to the MR element 8 through the ferromagnetic pieces 11 and 12, respectively. The conductors 13 and 14 in pair have other ends 13b and 14b thereof located at positions on the joint face 2a and apart from the medium sliding face m of the fist shield core 2, namely, on portions where the second shield core 3 is not joined to the first shield core 2.

There are formed on the other ends 13b and 14b of the pair of conductors 13 and 14 a pair of conductor portions 15 and 16, respectively, made of Cu, for example. The conductor portions 15 and 16 are formed to have a thickness of 80 μm or more, for example, and projected from the joint face 2a of the first shield core 2.

In the process of manufacturing the MR head 1, the conductor portions 15 and 16 are cut in the direction of their thickness when the substrate is cut into chips each of which is an MR head 1. The cut surfaces of the conductor portions 15 and 16 are exposed out on one face 2b of the first shield core 3, generally orthogonal to the medium sliding face m and joint face 2a (the face 2b will be referred to as “head side face” hereinunder). The exposed cut surfaces of the pair of conductor portions 15 and 16 are referred to as a pair of connecting terminals 17 and 18 for connection of the conductors 13 and 14 to a power source.

A second gap layer 19 made of Al₂O₃, for example, is formed between the magnetic sensor 4, pair of ferromagnetic pieces 11 and 12, pair of conductors 13 and 14 and second shield core 3. The second gap layer 19 and the aforementioned first gap layer 10 define together the gap g₁.

The portion apart from the medium sliding face m on the joint face 2a of the first shield core 2 and where the second shield core 3 is not joined is covered with a protective layer 20 made of an epoxy resin, for example, to protect the pair of conductors 13 and 14 and the pair of conductor portions 15 and 16.

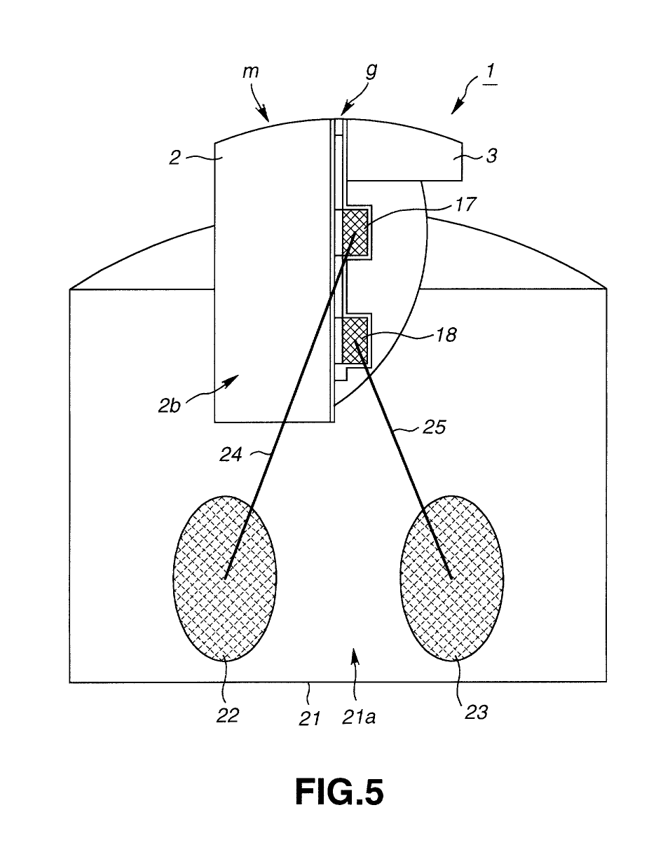

The MR head 1 constructed as having been described in the foregoing is installed at a face thereof generally parallel to the head side face 2b on a head base 21 as shown in FIG. 5.

The head base 21 has provided on a main surface 21a thereof a pair of terminal 22 and 23 connected to a power source. The MR head 1 are connected at the pair of connecting terminals 17 and 18 thereof to the pair of terminals 22 and 23, respectively, of the head base 21 through connecting members 24 and 25, respectively, such as a wire or the like. Thus the MR element 8 is connected to the power source and supplied with a sense current.

The pair of connecting terminals 17 and 18 of the MR head 1 are exposed on the head side face 2b generally parallel to the face of the MR head 1 at which the MR head 1 is attached to the main surface 21a of the head base 21. Therefore, the connecting terminals 17 and 18 of the MR head 1 and terminals 22 and 23 provided on the main surface 21a of the head base 21 are generally parallel to each other. Accordingly, an automatic wiring machine such as a wire-bonding machine can be used for easy connection of the connecting terminals 17 and 18 of the MR head 1 to the terminals 22 and 23, respectively, of the head base 21.

As mentioned above, the MR head 1 is installed on the head base 21, and the head base 21 with the MR head 1 is installed on a rotating drum with the pair of connecting terminals 17 and 18 connected to the par of terminals 22 and 23, respectively, of the head base 21. Thus, the MR head 1 is rotated as the rotating drum rotates and the medium sliding face m slides on a magnetic recording medium carrying an information signal recorded thereon. The resistance of the MR element 8 varies as a function of a magnetic field change corresponding to the information signal on the magnetic recording medium. Supplying a sense current to the MR element 8, the MR head 1 detects a resistance variation of the MR element 8 to read the information signal recorded on the magnetic recording medium.

In the foregoing, the present invention has been described concerning an embodiment in which the connecting terminals 17 and 18 in pair are exposed on the head side face 2b generally parallel to the face of the MR head 1 at which the MR head 1 is attached to the main surface 21a of the head base 21 and the connecting members 24 and 25 such as a wire or the like are used to connect the connecting terminals 17 and 18 to the pair of terminals 22 and 23, respectively, of the head base 21. However, the magnetic head according to the present invention is not limited to this embodiment but the exposed connecting terminals 17 and 18 on the face of the MR head 1 at which the MR head 1 is attached to the main surface 21a of the head base 21 may be connected directly to the pair of terminals 22 and 23, respectively, of the head base 21.

Also in the latter case, the conductor portions 15 and 16 are formed on, and projected from, portions on the joint face 2a of the first shield core 2 where the second shield core 3 is not joined to the first shield core 2 and the connecting terminals 17 and 18 are formed by cutting the conductor portions 15 and 16 in the direction of their thickness.

As in the above, the MR head 1 is once attached on the head base 21 and the head base 21 with the MR head 1 is installed on the rotating drum. However, the magnetic head according to the present invention is not limited to this embodiment but the magnetic head may be installed directly on the rotating drum.

In the latter case, the connecting terminals 17 and 18 are connected to terminals provided on the rotating drum.

Next, the method of manufacturing the aforementioned MR head 1 according to the present invention will be described hereunder.

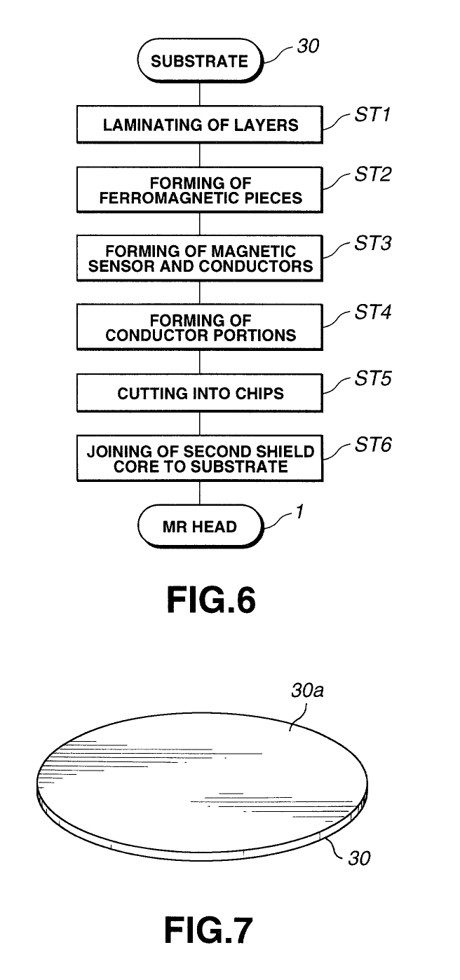

FIG. 6 is a flow chart of the process of manufacturing the MR head 1 according to the present invention. The MR head 1 is manufactured through a process consisting of steps ST1 at which layers are laminated on each other, ST2 at which a ferromagnetic piece is formed, ST3 at which a magnetic sensor and conductors are formed, ST4 at which conductor portions are formed, ST5 at which a formed chip is cut, and ST6 at which shield core blocks are joined to each other to form the MR head

First at the step ST1, a substrate 30 made of a soft magnetic material such as Ni—Zn ferrite, Mn—Zn ferrite or the like is prepared as shown in FIG. 7. The substrate 30 will be the first shield core 2 of the MR head 1. It is a disc-like one of 3 inches in diameter and 2 mm in thickness, for example. At least one side 30a of the substrate 30 is mirror-finished.

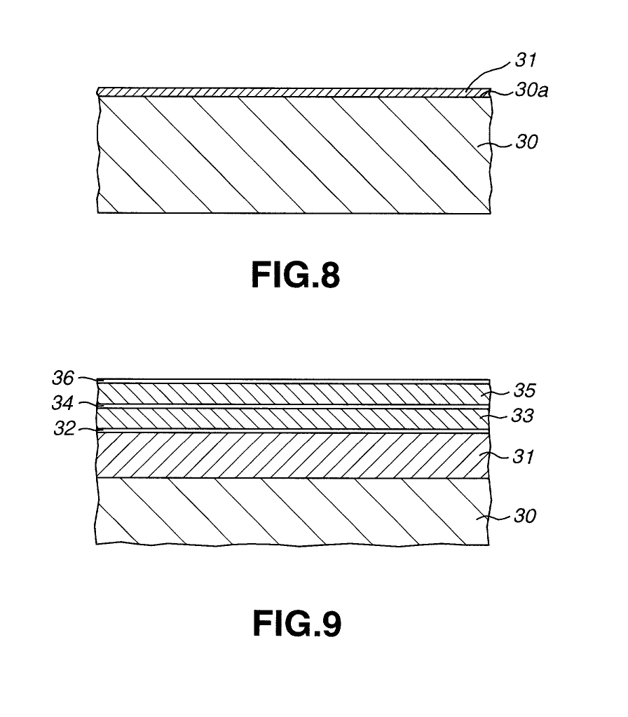

Then, a nonmagnetic, nonconductive material such as Al₂O₃, for example, is filmed on the mirror-finished circular surface 30a of the substrate 30 by sputtering or the like to form a first nonmagnetic, nonconductive layer 31, as shown in FIG. 8. The first nonmagnetic, nonconductive layer 31 will be the first gap layer 10 of the MR head 1 and its thickness depends upon a frequency, etc. used in a system to which the MR head 1 is applied. In this embodiment, the first nonmagnetic, nonconductive layer 31 is set to have a thickness of about 190 nm, for example.

Next, a nonmagnetic material such as Ta, soft magnetic material such as NiFeNb, nonmagnetic material such as Ta, soft magnetic material such as NiFeNb and nonmagnetic material such as Ta are filmed in this order on the first nonmagnetic, nonconductive layer 31 formed on the substrate 30 by sputtering or the like method to form a first nonmagnetic layer 32, SAL layer 33, second nonmagnetic layer 34, MR layer 35 and third nonmagnetic layer 36, respectively, as shown in FIG. 9.

The first nonmagnetic layer 32, SAL layer 33, second nonmagnetic layer 34, MR layer 35 and third nonmagnetic layer 36 will be the first nonmagnetic layer 5, SAL layer 6, second nonmagnetic layer 7, MR element 8 and third nonmagnetic layer 9, respectively, of the magnetic sensor 4 of the MR head 1. Their materials and thickness depend upon a system to which the MR head 1 is applied. For example, the first nonmagnetic layer 32 has a thickness of about 5 nm, SAL layer 33 has a thickness of about 43 nm, second nonmagnetic layer 34 has a thickness of about 5 nm, MR layer 35 has a thickness of about 40 nm, and the third nonmagnetic layer 36 has a thickness of about 1 nm, in this embodiment,

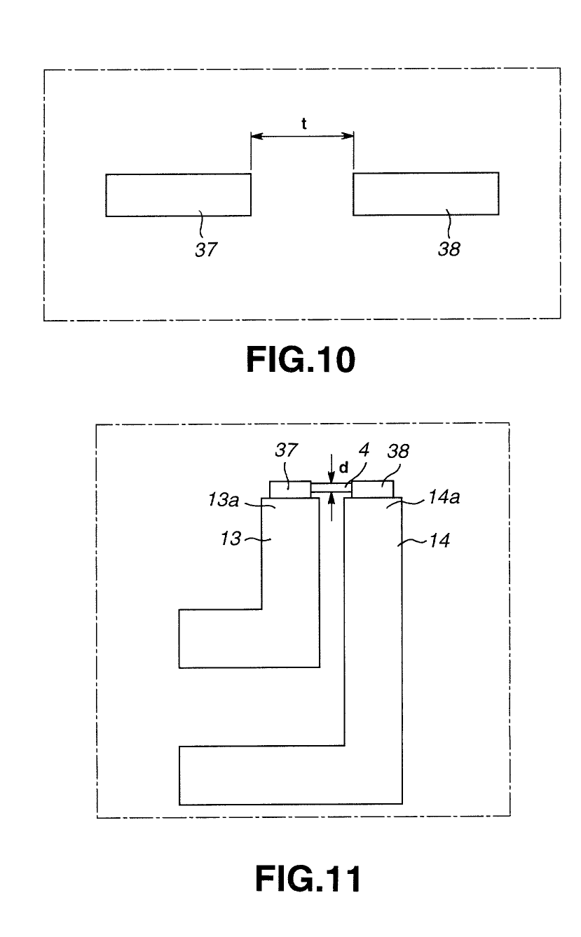

Next at the step ST2, a photoresist is patterned, by photolithography, on the substrate 30, on which the laminated layers forming the aforementioned magnetic sensor 4 are provided, to form ferromagnetic layers 37 and 38 which will form the ferromagnetic pieces 11 and 12 of the MR head 1. An ion etching is done using the photoresist as a mask to remove the laminated layers at predetermined places. A ferromagnetic material such as CoNiPt is filmed, by sputtering or the like method, at the places from which the laminated layers have been removed to form a pair of ferromagnetic layers 37 and 38 forming the ferromagnetic pieces 11 and 12, respectively, of the MR head 1 as shown in FIG. 10.

The ferromagnetic material should desirably have a coercivity of 1,000 Oe or more. For example, CoCrPt or the like is suitable for use as this ferromagnetic material in addition to CoNiPt. The thickness of the ferromagnetic layers 37 and 38 depends upon the system to which the MR head 1 is applied. In this embodiment, the ferromagnetic layers 37 and 38 have a width of about 50 μm and a length of 10 μm, and a nearly same thickness as the total thickness of the laminated layers forming together the magnetic sensor 4.

Since the laminated layers between the pair of ferromagnetic layers 37 and 38 form together the magnetic sensor 4 of the MR head 1, the distance t between the ferromagnetic layers 37 and 38 becomes the track width of the MR head 1. This distance t is also dependent upon the system to which the MR head 1 is applied. In this embodiment, the distance t is set about 5 μm, for example.

Next at the step ST3, a photoresist is patterned on a portion which becomes the magnetic sensor 4 of the MR head 1 and portions where the pair of conductors 13 and 14 are formed. The photoresist is used as mask in photoetching or the like to remove excessive laminated layers on other than the portion for the magnetic sensor 4 and portions for the pair of conductors 13 and 14, as shown in FIG. 11.

It should be noted that since the length d of the magnetic sensor 4 is the depth of the MR element 8 of the MR head 1, the length d of the magnetic sensor 4 is also dependent upon the system to which the MR head 1 is applied. In this embodiment, the length d of the magnetic sensor 4 is about 4 μm.

Next, to replace the laminated layers at which the pair of conductors 13 and 14 are formed with a metal layer having a smaller electrical resistance, a photoresist is patterned on other than the portions where the pair of conductors 13 and 14 are to be formed. The photoresist is used as mask in ion-etching or the like to remove the laminated layers from the portions at which the pair of conductors 13 and 14 are to be formed.

Furthermore, metallic materials such as Ti, Cu and the like are filmed on the photoresist layer by sputtering or the like method to form the conductors 13 and 14 connected at one ends 13a and 14a thereof to the pair of ferromagnetic layers 37 and 38, respectively. The metallic layers filmed on other portions than the conductors 13 and 14 are lifted off for removal during removal of the photoresist by washing. The thickness of the conductors 13 and 14 depends upon the system to which the MR head 1 is applied. In this embodiment, however, the Ti layer is about 15 nm thick and the Cu layer is about 70 nm thick.

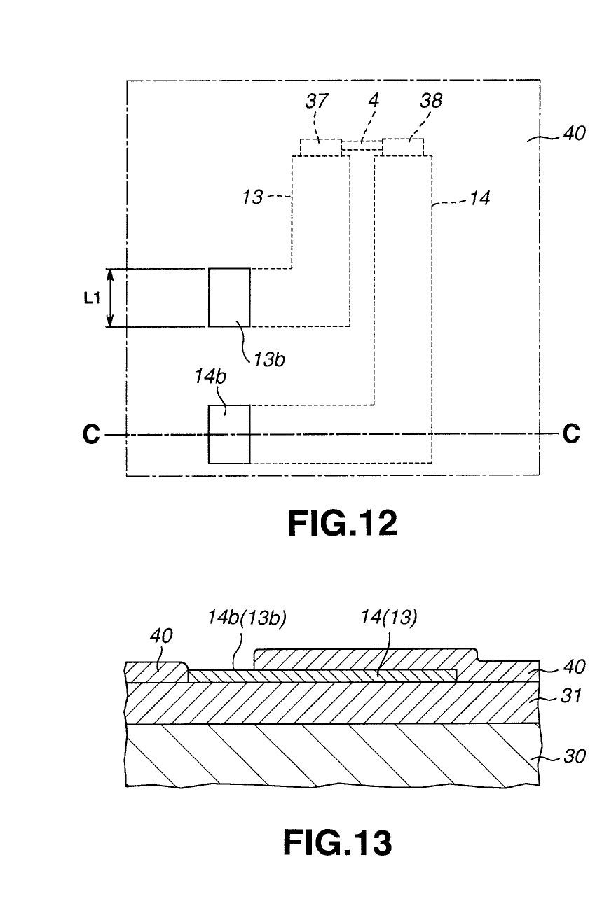

Next at the step ST4, the photolithography is used to pattern a photoresist layer 40 of about 1 μm in thickness on a portion other than other ends 13b and 14b of the pair of conductors 13 and 14, respectively, in order to form a pair of conductor portions 15 and 16 as shown in FIGS. 12 and 13. The length L1 of a portion where the photoresist layer 40 is not applied is one side of the pair of connecting terminals 17 and 18 of the MR head 1. The length L1 should desirably be 80 μm or more for the pair of connecting terminals 17 and 18 to have a sufficient area for wire-bonding of them. Note that FIG. 13 is a sectional view taken along the line C-C in FIG. 12.

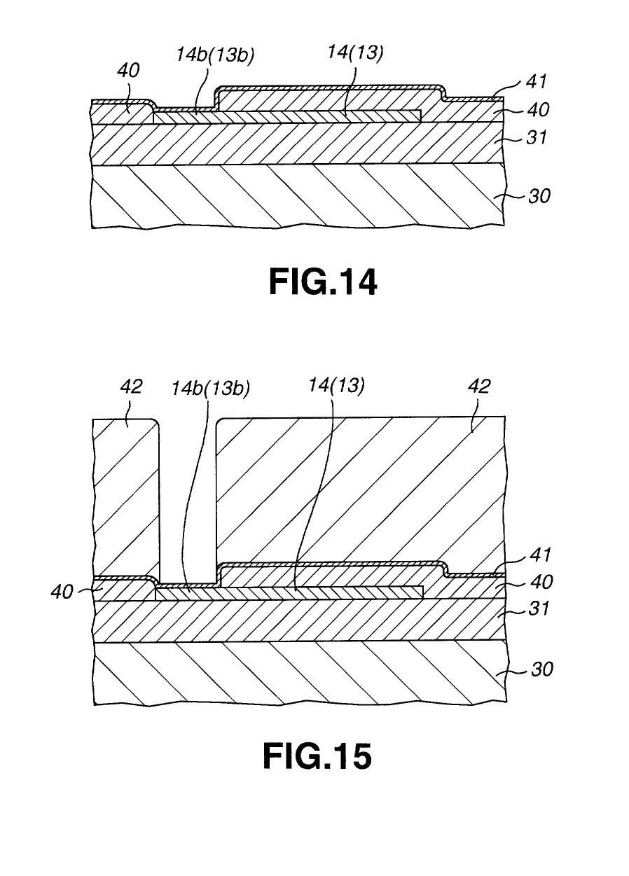

Next, a metallic material such as Cu is filmed to thickness of about 30 nm on the entire surface, as shown in FIG. 14, to form a thin metallic film 41 on which the conductor portions 15 and 16 will be formed.

Then, a photoresist layer 42 is applied to a thickness of about 100 μm on other than near the other ends 13b and 14b of the pair of conductors 13 and 14 as shown in FIG. 15. The photoresist layer 42 is formed by applying a photoresist material for thick layer such as AZ4903 (trade name) to the substrate 30 being rotated at a low speed or by coating the photoresist material onto the substrate 30 repeatedly several times. Otherwise, the photoresist layer 42 may be formed by heating a sheet photoresist of about 100 μm in thickness and attaching it under pressure.

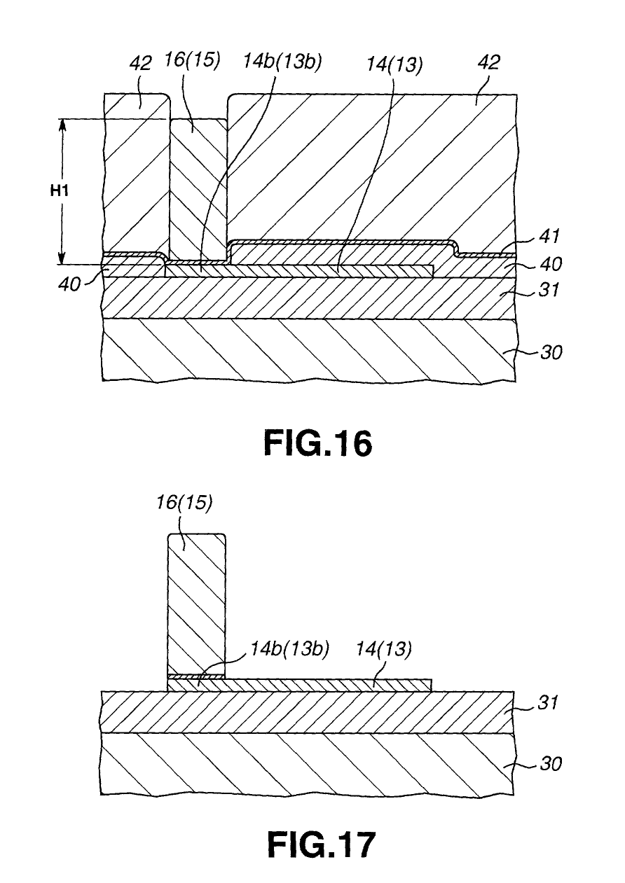

Next, the photoresist layer 42 is used as mask to form the conductor portions 15 and 16 on the other ends 13b and 14b of the pair of conductors 13 and 14 by an electroplating using a copper sulfate solution, for example, as shown in FIG. 16. The conductor portions 15 and 16 may be formed from any metallic material which would not adversely affect the other parts, such as copper pyrophosphate.

The width H1 of the conductor portions 15 and 16 is one side of the pair of connecting terminals 17 and 18 of the MR head 1. Similarly to the aforementioned length L1 of the portions where the photoresist 40 is not applied, this width HI should desirably be 80 μm or more to assure a sufficient area of the pair of connecting terminals 17 and 18 to connect them by wire-bonding.

Note that the conductor portions 15 and 16 may be formed by charging a conducive paste into a spare defined by the photoresist 42, namely, onto the other ends 13b and 14b of the pair of conductors 13 and 14, instead of the electroplating. Also in this case, the thickness H1 of the conductor portions 15 and 16 should desirably be 80 μm or more.

Next, the substrate 30 is washed using an organic solvent to remove the photoresists 40 and 42 as shown in FIG. 17, so that the conductor portions 15 and 16 are formed to project from the substrate 30.

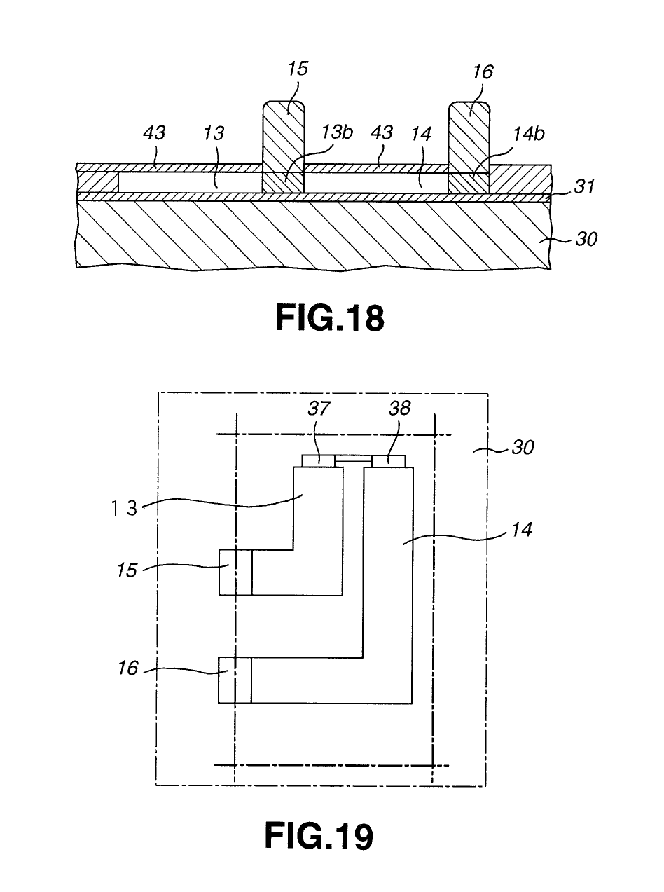

As shown in FIG. 18, a nonmagnetic, nonconductive material such as Al₂O₃ is filmed, by sputtering or the like method, over a portion of the substrate 30 on which at least the laminated layers forming the magnetic sensor 4, ferromagnetic layers 37 and 38 and the one ends 13a and 14a of the pair of conductors 13 and 14 are formed. Thus the nonmagnetic, nonconductive material forms a second nonmagnetic, nonconductive layer 43 which provides the second gap layer 19 of the MR head 1. Similarly to the first nonmagnetic, nonconductive layer 31, the second nonmagnetic, nonconductive layer 43 has a thickness depending upon the frequency, etc. used in a system to which the MR head 1 is applied. In this embodiment, the second nonmagnetic, nonconductive layer 43 is set to have a thickness of about 180 nm, for example. Note that a part of the second nonmagnetic, nonconductive layer 43 is omitted in FIG. 18.

Next at the step ST5, the substrate 30 processed as having been described in the foregoing is cut into chips. As shown in FIG. 19, the substrate 30 is cut along cutting lines (dashed line) one of which passes through the pair of conductor portions 15 and 16. Thus, the cut surfaces of the conductor portions 15 and 16 will be exposed in a plane in which the cut surface of the substrate 30 lies. The cut surfaces of the conductor portions 15 and 16, exposed on the cut surface of the substrate 30 are the connecting terminals 17 and 18 of the MR head 1.

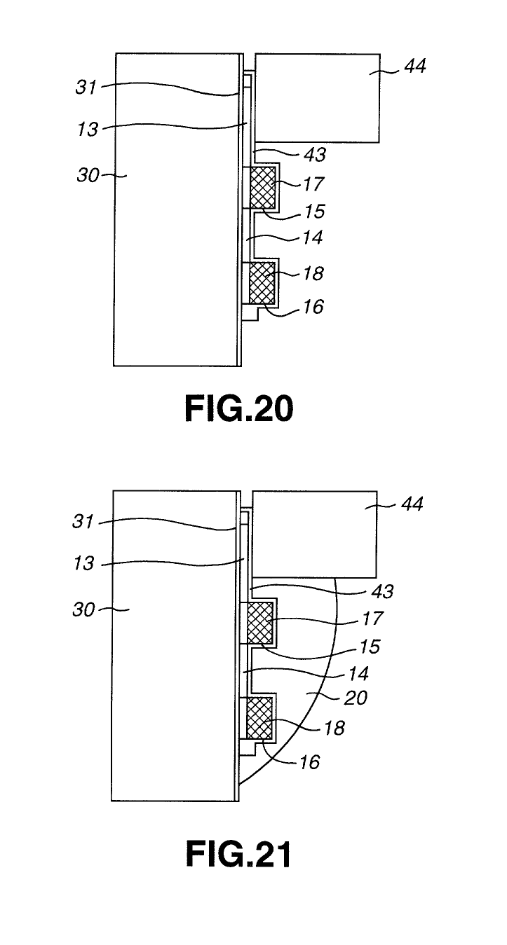

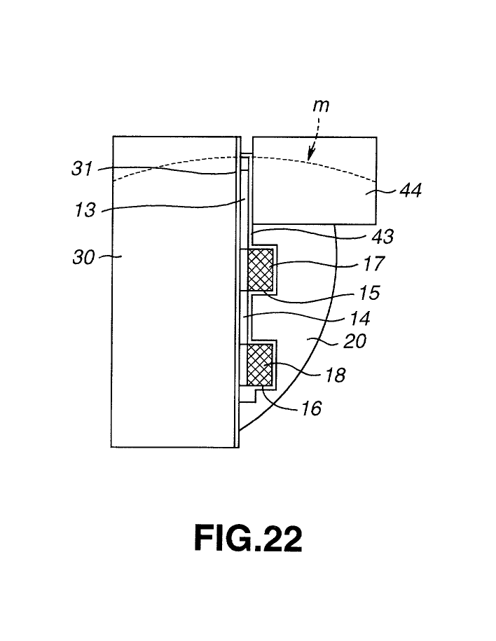

Next at the step ST6, a core block 44 being the second shield core 3 is joined to each of the chips obtained by cutting the substrate 30 as in the above to cover the laminated layers being the magnetic sensor 4, ferromagnetic layers 37 and 38 and the one ends 13a and 14a of the pair of conductors 13 and 14 as shown in FIG. 20. The other ends 13b and 14b of the pair of conductors 13 and 14 and conductor portions 15 and 16, are exposed out. Note that like the substrate 30, the core block 44 is formed from a soft magnetic material such as Ni—Zn ferrite, Mn—Zn ferrite or the like.

Next, a protective material 20 such as epoxy resin or the like is applied to other than the exposed other ends 13b and 14b of the pair of conductors 13 and 14 and exposed cut surfaces off the conductor portions 15 and 16 as shown in FIG. 21 to shield off the atmosphere.

Then, the portion of each chip including the substrate 30 and the laminated layers provided in the core block 44 and serving as the magnetic sensor 4 are provided is cylindrically ground to form the medium sliding face m, as shown in FIG. 21. As the result of this cylindrical grinding, the ends of the laminated layers being the magnetic sensor 4 are exposed out. Thus the MR head 1 having been shown in FIG. 2 is completed.

Next, the joint face generally parallel to the side (head side face 2b) on which the connecting terminals 17 and 18 are exposed is joined to the main surface 21a of the head base 21 to attach to the head base 21 the MR head 1 completed as having been described in the above. The connecting terminals 17 and 18 of the MR head 1 are connected to the pair of terminals 22 and 23 disposed on the main surface 21a of the head base 21 by means of the connecting members 24 and 25, respectively, such as a wire or the like. Since the connecting terminals 17 and 18 of the MR head 1 and the terminals 22 and 23 of the head base 21 are disposed on generally parallel surfaces, respectively, namely, they are generally parallel to one another, an automatic wiring machine such as a wire-bonding machine or the like can be used to easily connect them to each other.

Also the MR head 1 may have the connecting terminals 17 and 18 exposed from the joint face. In this case, the connecting terminals 17 and 18 of the MR head 1 can be connected directly to the terminals 22 and 23 of the head base 21, without using the connecting members 24 and 25 such as a wire or the like.

Next, another embodiment of the present invention, applied to a so-called bulk thin-film type magnetic head in which coil forming concavities are formed in a joint face of at least one of a pair of magnetic core half blocks to be joined integrally to each other with a magnetic gap thus defined between them and thin-film coils are formed in the coil forming concavities, will be described hereinunder.

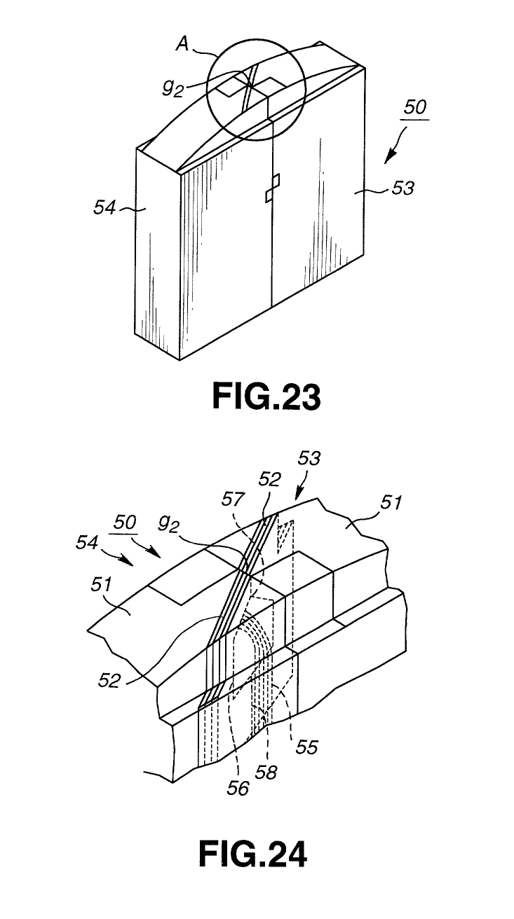

Referring now to FIGS. 23 and 24, there is illustrated a bulk thin-film type magnetic head generally indicated with a reference 50. As shown, the bulk thin-film type magnetic head 50 comprises a nonmagnetic substrate 51 to which magnetic core half blocks 53 and 54 in pair, in which a magnetic metal layer 52 to be a magnetic core is formed, are joined integrally to each other by a low-temperature metal diffused junction. A magnetic gap g₂ is thus defined between the joint faces of the magnetic core half blocks 53 and 54. The bulk thin-film type magnetic head 50 has formed in the joint face of at least one (53) of the pair of magnetic core half blocks 53 and 54 coil forming concavities (not shown) in which a thin-film coil 55 for excitation of the magnetic head 50 or for detection of induced electromotive force is formed. Note that FIG. 24 shows, enlarged in scale, the portion A in FIG. 23.

Also the bulk thin-film type magnetic head 50 has a winding recess 56 formed in the joint faces of the pair of magnetic core half blocks 53 and 54 in which the magnetic metal layer 52 is formed, to isolate a part of the joint face of the magnetic metal layer 52. Therefore, in this bulk thin-film type magnetic head 50, the winding recess 56 divides the magnetic gap g₂ into a front gap 57 and back gap 58 working as actuation gap.

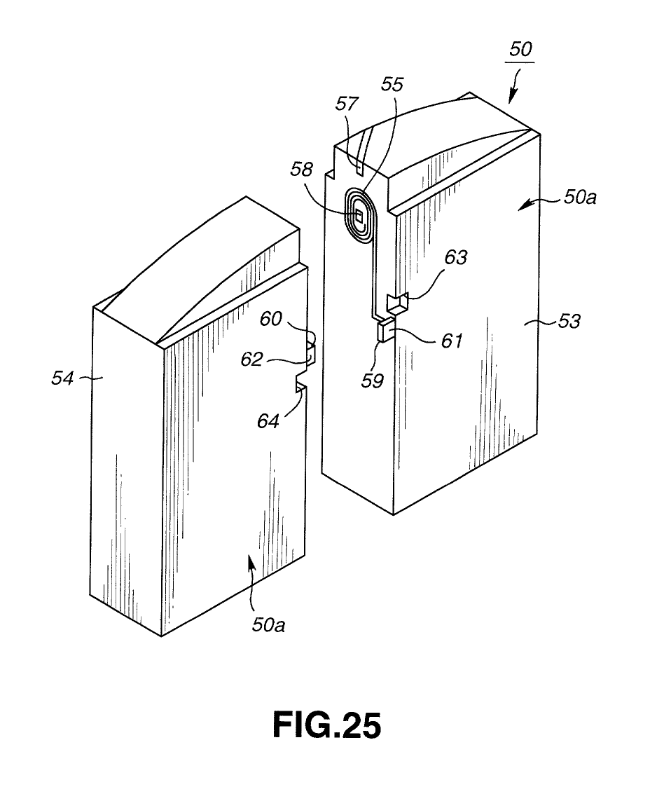

As shown in FIG. 25, the magnetic core half blocks 53 and 54 in pair of this bulk thin-film type magnetic head 50 have provided thereon conductor portions 59 and 60, respectively, projecting from their respective joint faces to lead out coil terminals. When the bulk thin-film type magnetic head 50 is cut into chips in the manufacturing process, the conductor portions 59 and 60 are cut in the direction of their thickness so that their cut surfaces thus resulted will be exposed on a head side face 50a of the magnetic head 50. The exposed cut surfaces of the conductor portions 59 and 60 are to be connecting terminals 61 and 62 for connection to a power source to supply a current to the thin-film coil 55. Furthermore, the pair of magnetic core half blocks 53 and 54 has formed in the joint faces thereof concavities 63 and 64, respectively, into which the conductor portions 59 and 60 of the pair of the magnetic core half blocks 53 and 54 are fitted when the magnetic core half blocks 53 and 54 are joined integrally to each other.

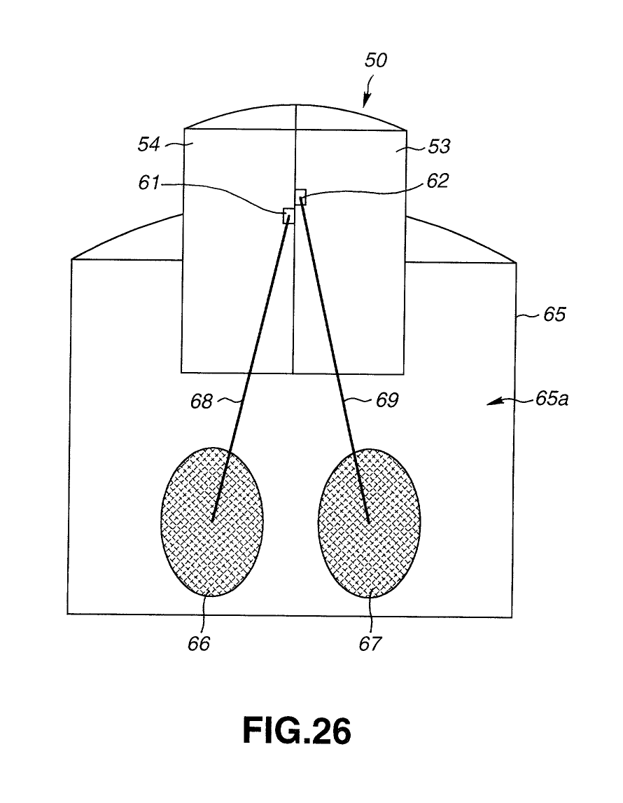

As shown in FIG. 26, the bulk thin-film type magnetic head 50 constructed as having been described in the foregoing is attached at surfaces thereof opposite and generally parallel to the head side face 50a to a head base 65.

The head base 65 has provided on a main surface 65a thereof a pair of terminals 66 and 67 connected to a power source. The bulk thin-film type magnetic head 50 is connected to the power source by connecting the pair of connecting terminals 61 and 62 thereof to the pair of terminals 66 and 67, respectively, of the head base 65 by means of connecting members 68 and 69, respectively, such as a wire or the like so that the thin-film coil 55 is supplied with a drive current.

As mentioned in the foregoing, the bulk thin-film type magnetic head 50 has the pair of connecting terminals 61 and 62 exposed on the head side face 50a opposite and generally parallel to the joint face of the magnetic head 50 at which the magnetic head 50 is joined to the main surface 65a of the head base 65. So the connecting terminals 61 and 62 of the bulk thin-film type magnetic head 50 are generally parallel to the terminals 66 and 67 provided on the main surface 65a of the head base 65. Hence, the connecting terminals 61 and 62 of the bulk thin-film type magnetic head 50 can easily be connected to the terminals 66 and 67 of the head base 65 using an automatic wiring machine such as a wire-bonding machine or the like.

As mentioned above, the bulk thin-film type magnetic head 50 is attached to the head base 65 and its pair of connecting terminals 61 and 62 is connected to the pair of terminals 66 and 67, respectively, provided on the head base 65. The bulk thin-film type magnetic head 50 thus constructed is mounted on a rotating drum, for example. The magnetic head 50 thus installed on the rotating drum slides on a magnetic recording medium while being rotated as the rotating drum rotates, to write or read an information signal into or from the magnetic recording medium.

The bulk thin-film type magnetic head being the second embodiment of the present invention having been described in the foregoing having the connecting terminals 61 and 62 thereof exposed on the head side face 50a opposite and generally parallel to the joint face of the magnetic head 50 at which the magnetic head 50 is attached to the main surface 65a of the head base 65, and connected to the pair of terminals 66 and 67, respectively, of the head base 65 with the connecting members 68 and 69, respectively, such as a wire or the like. The magnetic head according to the present invention is not limited to this second embodiment but may have the connecting terminals 61 and 62 exposed on the joint face at which the magnetic head 50 is attached to the main surface 65a of the head base 65, and connected directly to the pair of terminals 66 and 67, respectively, of the head base 65, not with such connecting members.

Also in this case, the connecting terminals 61 and 62 are obtained by cutting, in the direction of thickness, the conductor portions 59 and 60 projecting from the joint faces of the pair of magnetic core half blocks 53 and 54.

In the second embodiment, the bulk thin-film type magnetic head 50 is attached to the head base 65 and then installed on the rotating drum as having been described in the foregoing. However, the present invention is not limit to this embodiment, but the magnetic head may be installed directly to the rotating drum.

In this case, the connecting terminals 61 and 62 will be connected to terminals provided on the rotating drum.

Next, the method of manufacturing the bulk thin-film type magnetic head 50 will be described hereinunder.

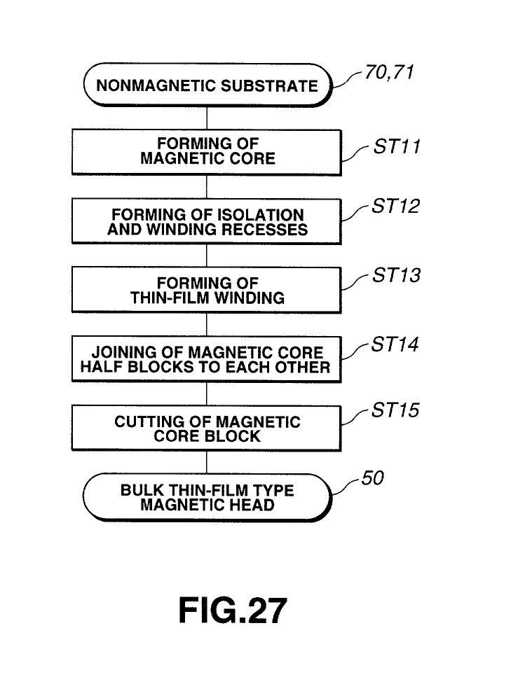

Referring now to FIG. 27, there is shown a flow chart of the process of manufacturing the bulk thin-film type magnetic head 50 according to the present invention, of which the construction has been described in the foregoing. The bulk thin-film type magnetic head 50 is manufactured through a process consisting of steps ST11 at which a magnetic core is formed, ST12 at which isolation and winding recesses are formed, ST13 at which a thin-film coil is formed, ST14 at which magnetic core half blocks are joined to each other, and ST15 at which the joined magnetic core block is cut.

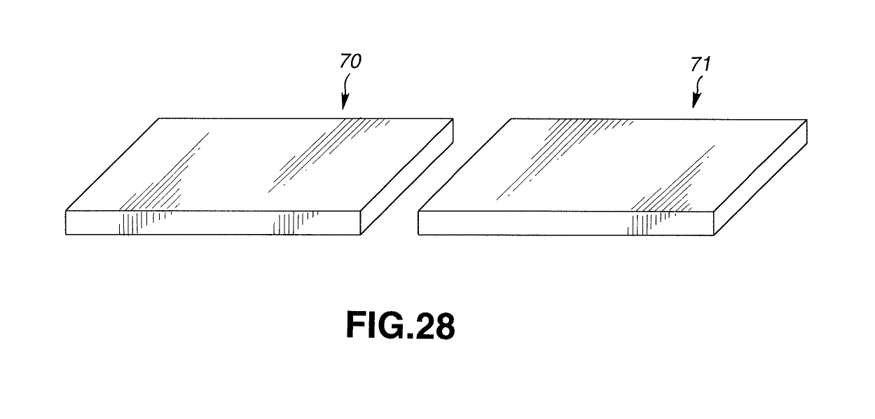

First at the step ST11, a pair of nonmagnetic substrates 70 and 71 having the general form of a plate is prepared as shown in FIG. 28. The nonmagnetic substrates 70 and 71 will finally be cut to form the nonmagnetic substrate 51 of the aforementioned bulk thin-film type magnetic head 50. They are made of a material superior in slidability, abrasion resistance and machinability such as calcium titanate, potassium titanate, barium titanate, zirconium oxide (zirconia), alumina, aluimina titanium carbide, SiO₂, MnO—NiO sintered mixture, Zn ferrite, crystal glass, high-hardness glass or the like. In this embodiment, the substrates 70 and 71 are made of an MnO—NiO sintered mixture of about 2 mm in thickness and about 30 mm in length and width.

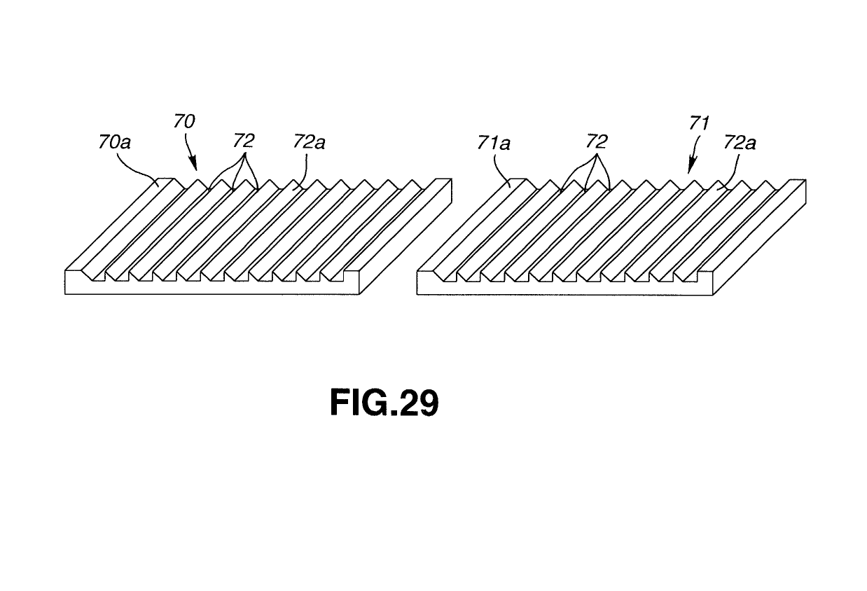

As shown in FIG. 29, the nonmagnetic substrates 70 and 71 in pair have main surfaces 70a and 71a, respectively. There is formed in each of the main surfaces 70a and 71a a plurality of magnetic core forming recesses 72 each having a slope 72a of a predetermined angle. The inclination angle of the slope 72a of each magnetic core forming recess 72 is set within a range of 25 to 60 deg. Taking the pseudo gap and track width precision taken in consideration, the inclination angle of the slope 72a should desirably be within a range of about 35 to 50 deg. In this embodiment, each magnetic core forming recess 72 has the slope 72a forming an angle of 45 deg. with respect to the main surfaces 70a and 71a of the nonmagnetic substrates 70 and 71, is about 130 μm deep and about 150 μm wide. The magnetic core forming recess 72 is formed using a grindstone beveled at one side thereof.

Next, a PVD or CVD method such as magnetron sputtering is used to form, to a uniform thickness, a magnetic metal layer 73 on the slopes 72a of the magnetic core forming recesses 72, as shown in FIG. 30. The magnetic metal layer 73 is to be the magnetic metal layer 52 finally forming the magnetic core of the bulk thin-film type magnetic head 50. It is made of a material showing a high saturation-magnetizability, high permeability and a great easiness of filming such as any one selected from the group of crystalline alloys including Sendust (Fe—Al—Si alloy), Fe—Al alloy, Fe—Si—Co alloy, Fe—Ga—Si alloy, Fe—Ga—Si—Ru alloy, Fe—Al—Ge alloy, Fe—Ga—Ge alloy, Fe—Si—Fe alloy, Fe—Co—Si—Al alloy, Fe—Ni alloy, etc. Alternatively, the magnetic metal layer 73 may be formed from any one selected from the group of amorphous alloys including an alloy comprising more than one of Fe, Co and Ni and more than one of P, C, B and Si, a metal-metalloid amorphous alloy represented by an alloy based on the above alloy and containing Al, Ge, Be, Sn, In, Mo, W, Ti, Mn, Cr, Zr, Hf, Nb or the like, a metal-metal amorphous alloy comprising a transition metal such as Co, Hf, Zr or the like and a rare earth element as main components.

The magnetic metal layer 73 may be a monolayer of the above-mentioned material. However, note that for a higher magnetic sensitivity in a high frequency domain, the layer 73 should desirably be of a laminated structure in which the magnetic metal layer is isolated by nonmagnetic layers to a plurality of layers. The laminated structure of the magnetic metal layer 73, consisting of the magnetic metal layers and nonmagnetic layers, permits to reduce the eddy current loss. In this case, the thickness of the nonmagnetic layers should be larger than required for a minimum effect of insulation. In this embodiment, however, the nonmagnetic layer thickness is such that it will not work as any pseudo gap. In this embodiment, the magnetic metal layer 73 comprises three magnetic metal layers of Sendust having a thickness of about 5 μm and nonmagnetic layers of alumina of about 0.15 μm in thickness, disposed alternately.

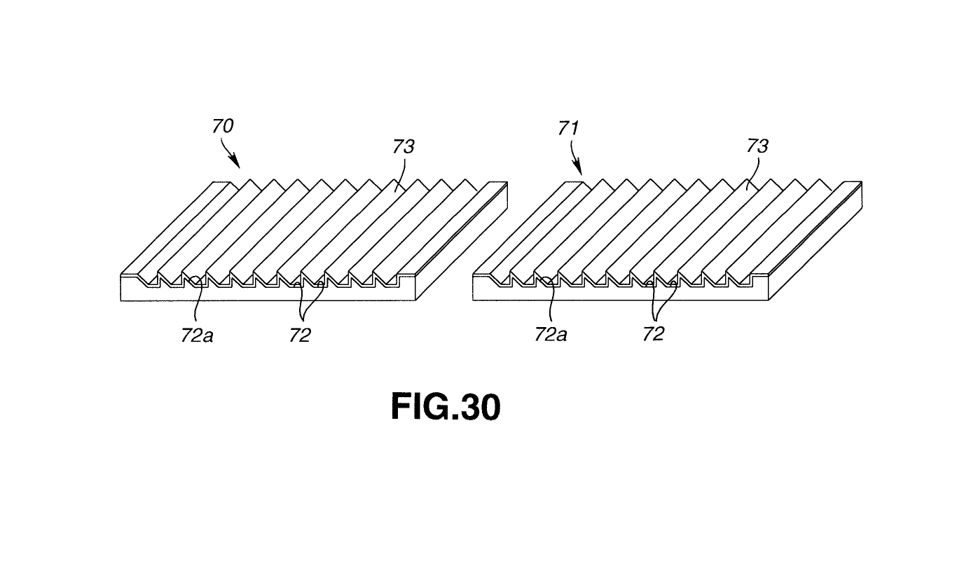

Next at the step ST12, isolation recesses 74 and winding recesses 75 are alternately formed in the main surfaces 70a and 71a of the nonmagnetic substrates 70 and 71 in directions orthogonal to the magnetic core forming recesses 72 as shown in FIG. 31.

The isolation recesses 74 are provided to magnetically isolate the magnetic metal layer 73 in forming a magnetic core and form a closed magnetic circuit when the bulk thin-film type magnetic head 50 is finally formed. Therefore, the isolation recess 74 should be deep enough to positively isolate the magnetic metal layer 73 but is not limited in its shape. In this embodiment, the isolation recess 74 is about 150 μm deeper than the bottom of the magnetic core forming recess 72, namely, it is about 280 μm deep, and has the general sectional shape of C.

The winding recess 75 is provided to wind the thin-film coil 55 which will be formed in a later step and isolate the front and back gaps 57 and 58 from each other when the bulk thin-film type magnetic head 50 is finally formed. Therefore, the winding recess 75 should be formed to have a depth which will not cut into the magnetic metal layer 73. Further, the winding recess 75 is dependent in shape upon the lengths of the front and back gaps 57 and 58. In this embodiment, the winding recess 75 is set to have a width of about 140 μm such that the front gap 57 has a length of about 300 μm while the back gap 58 has a length of about 85 μm.

Further, the winding recess 75 is so shaped that the end of the front gap 57 will form an acute angle when the bulk thin-film type magnetic head 50 is finally formed, which will better concentrate the magnetic flux and improve the sensitivity of the magnetic head in recording an information signal. Accordingly, the winding recess 75 should desirably be shaped such that the front gap 57 is inclined. In this embodiment, the winding recess 75 is shaped for the front gap 57 to have a slope of 45 deg.

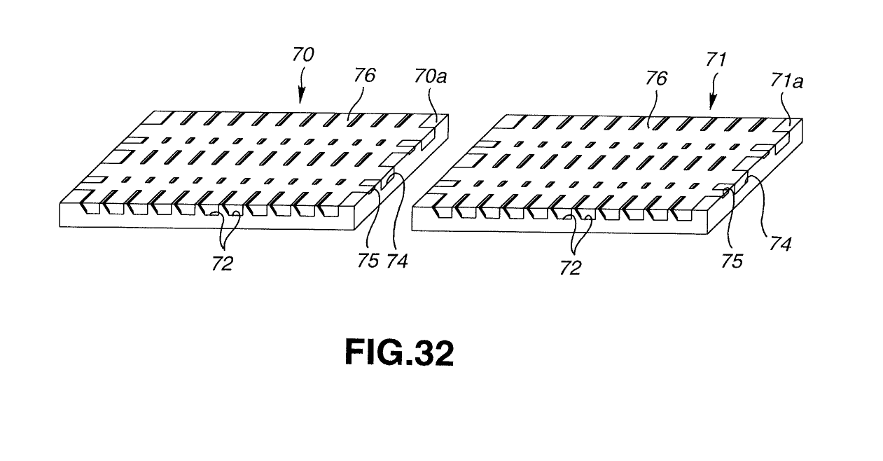

Next, a molten glass 76 having a low melting point is charged onto the main surfaces 70a and 71a of the nonmagnetic substrates 70 and 71, as shown in FIG. 32, on which the magnetic core forming recesses 72, isolation recesses 74 and winding recesses 75 are formed as having been described in the above. The main surfaces 70a and 71a of the nonmagnetic substrates 70 and 71, on which the molten glass has been charged, are flattened by polishing or otherwise.

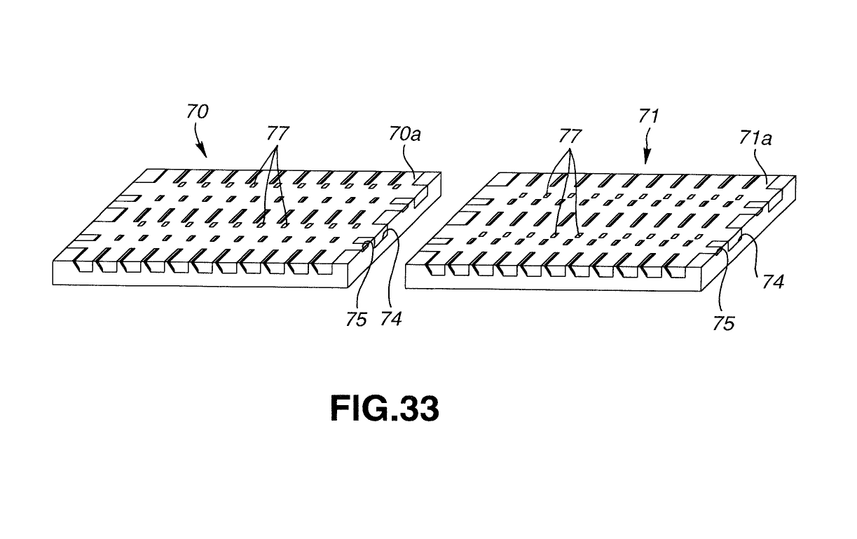

Next at the step ST13, an ion-etching or the like is effected to form concavities 77 in place on the flattened main surfaces 70a and 71a of the nonmagnetic substrates 70 and 71 as shown in FIG. 33. The concavities 77 will finally be the recesses 63 and 64 in the bulk thin-film magnetic head 50, into which the conductor portions 59 and 60 are to be fitted. Thus, the concavities 77 are shaped correspondingly to the conductor portions 59 and 60.

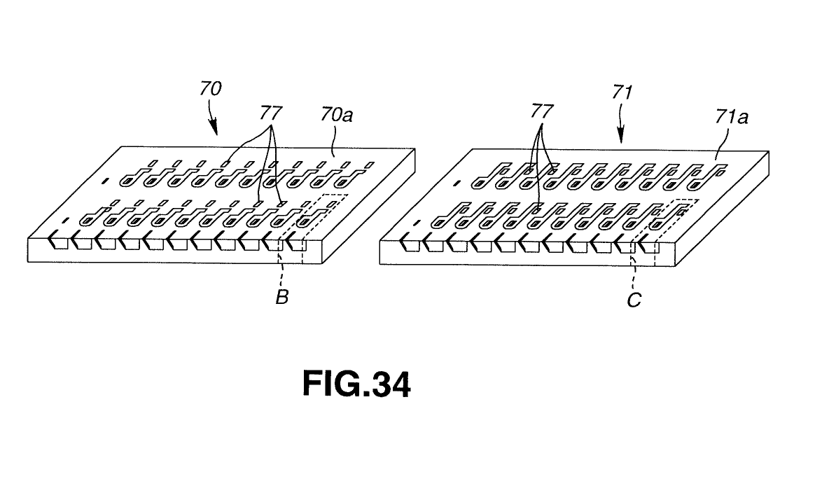

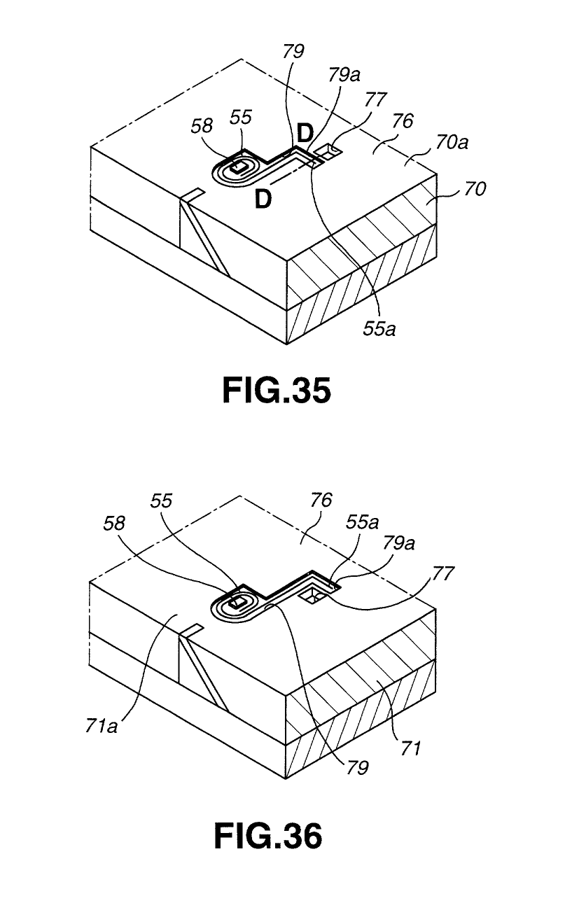

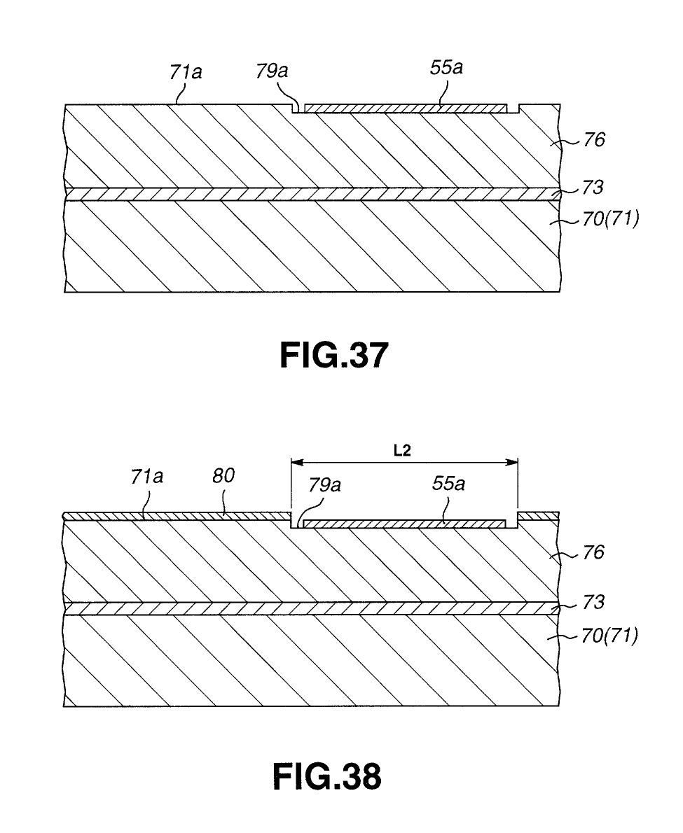

Next, coil forming concavities 79 are formed in the main surfaces 70a and 71a of the nonmagnetic substrates 70 and 71 as shown in FIGS. 34 through 37. The coil forming concavity 79 is shaped to have a form corresponding to that of the coil shape. Thereafter, the thin-film coil 55 is formed in the coil forming concavity 79 by electroplating or the like. The coil forming concavity 79 includes, at one end thereof, a portion 79a in which a terminal 55a of the thin-film coil 55 is to be formed. FIG. 35 is a view, enlarged in scale, of a portion B in FIG. 34, FIG. 36 is a view, enlarged in scale, of a portion C in FIG. 34, and FIG. 37 is a sectional view taken along the line D-D in FIG. 35.

Here, the coil forming concavity 79 is formed in one (70) of the pair of nonmagnetic substrates 70 and 71 so that the coil terminal housing portion 79a thereof is positioned at the side of the back gap 58 with reference to the concavity 77, as shown in FIG. 35. The thin-film coil 55 is formed inside the coil forming concavity 79 with the coil terminals 55a located at the side of the back gap 58 with reference to the concavity 77.

On the other hand, the coil forming concavity 79 is formed in the other (71) of the pair of nonmagnetic substrates 70 and 71 with the coil terminal housing portion 79a thereof located away from the back gap 58 with reference to the concavity 77, as shown in FIG. 36. The thin-film coil 55 is formed inside the coil forming concavity 79 so that the coil terminals 55a are located away from the back gap 58 with reference to the concavity 77.

When the pair of nonmagnetic substrates 70 and 71 are butt-joined to each other, the coil terminals 55a of the thin-film coil 55 formed on one of the nonmagnetic substrates (70) are opposite to the concavity 77 formed in the other nonmagnetic substrate (71) while the coil terminals 55a of the thin-film coil 55 formed on the other nonmagnetic substrate 71 are opposite to the concavity 77 formed in the one nonmagnetic substrate 70.

Next, a photolithography is used to pattern a photoresist 80 of about 1 μm in thickness on other than the coil terminal housing portion 79a of the coil forming concavity 79 as shown in FIG. 38. The width L2 of the coil terminal housing portion 79a on which the photoresist 80 is not applied forms one side of the pair of connecting terminals 61 and 62 of the bulk thin-film type magnetic head 50. Therefore, the width L2 should desirably be 80 μm or more for the connecting terminals 61 and 62 to have such a sufficient area that they can be connected by a wire-bonding machine or the like.

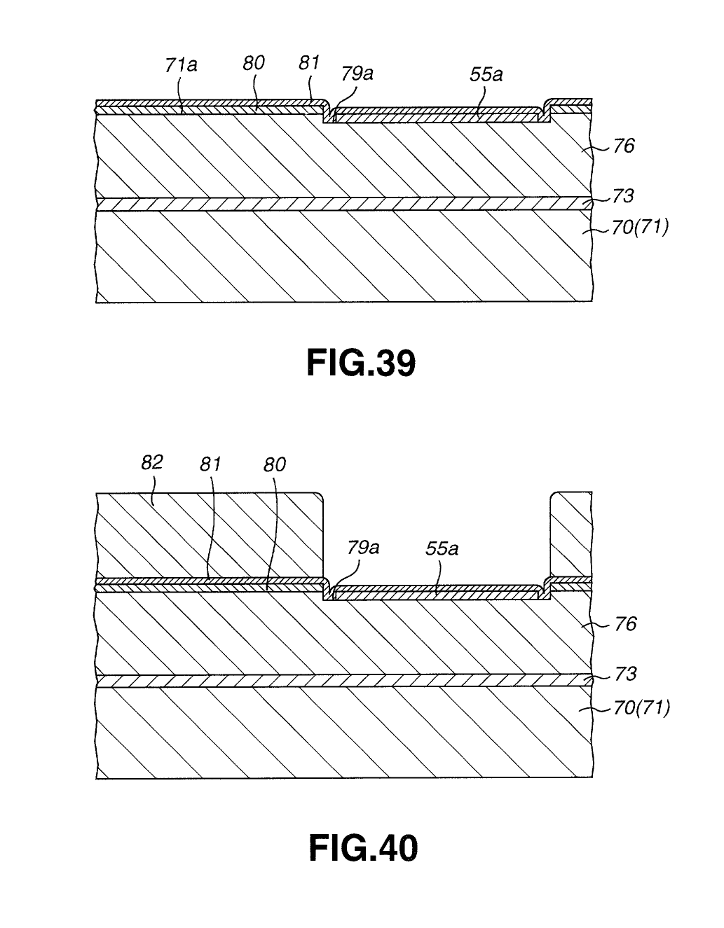

Next, a metallic material such as Cu or the like is filmed by sputtering or the like with the photoresist 80 used as a mask to have a thickness of about 30 nm, as shown in FIG. 39, to form a thin metal film 81 from which the conductor portions 59 and 60 are to be formed.

Then, a photoresist 82 of about 100 μm in thickness is formed on other than the coil terminal housing portion 79a of the coil forming concavity 79 as shown in FIG. 40. The photoresist 82 is made of AZ4903 (trade name), for example, which is for a thick film. It is applied onto the nonmagnetic substrates 70 and 71 being rotated at a very slow speed or applied repeatedly several times onto the nonmagnetic substrates 70 and 71.

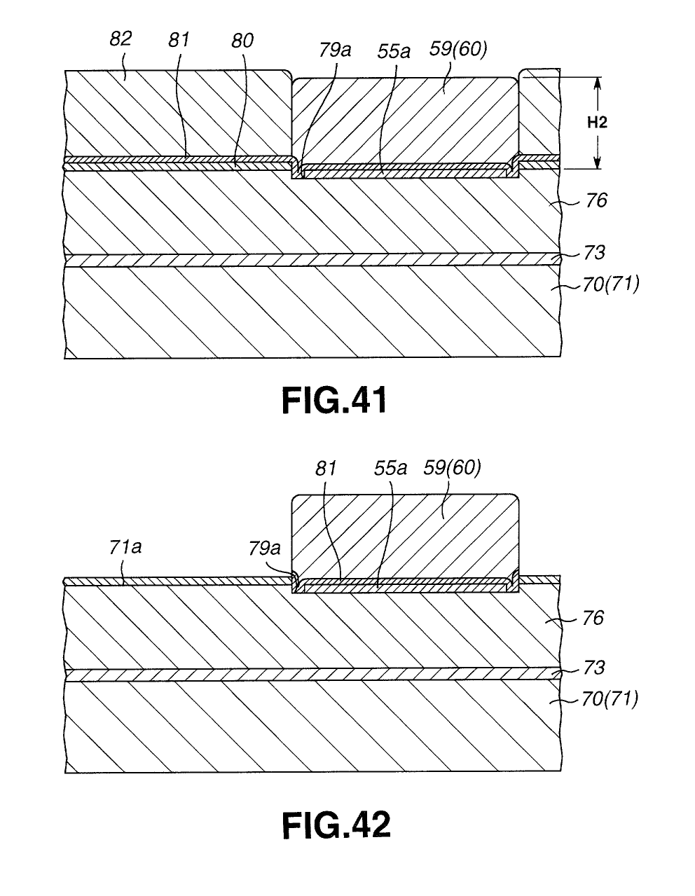

Next, an electroplating using a copper sulfate solution, for example, is effected using the photoresist 82 as a mask to form the conductor portions 59 and 60, connected to the thin-film coil 55, on the coil terminal housing portion 79a of the coil forming concavity 79, as shown in FIG. 41. The conductor portions 59 and 60 may be formed from any metallic material which would not adversely affect the other parts, such as copper pyrophosphate.

The thickness H2 of the conductor portions 59 and 60 forms one side of the connecting terminals 61 and 62 of the bulk thin-film type magnetic head 50. So, the thickness H2 should desirably be 80 μm or more, similarly to the length L2 of the portion on which the photoresist 80 is not applied, for the connecting terminals to have a sufficient area to wire them by a wire-bonding machine or the like.

Note that the conductor portions 59 and 60 may be formed by charging a conductive paste or the like onto a region surrounded by the photoresist 82, that is to say, onto the coil terminal housing portion 79a of the coil forming concavity 79, instead of the electroplating or the like. Also in this case, the thickness H2 of the conductor portions 59 and 60 should desirably be 80 μm or more.

Next, the nonmagnetic substrates 70 and 71 are washed using an organic solvent to remove the photoresists 80 and 82 as shown in FIG. 42. Thus, the conductor portions 59 and 60 are projected from the nonmagnetic substrates 70 and 71.

Then, a coil protective layer (not shown) is formed on the thin-film coil 55 to protect the thin-film coil 55 from contact with the atmosphere. The coil protective layer is made of Al₂O₃ or the like and charged into the coil forming concavity 79.

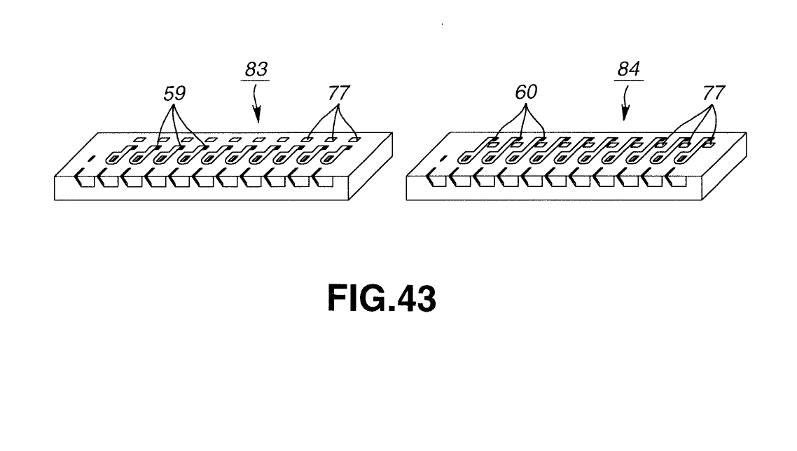

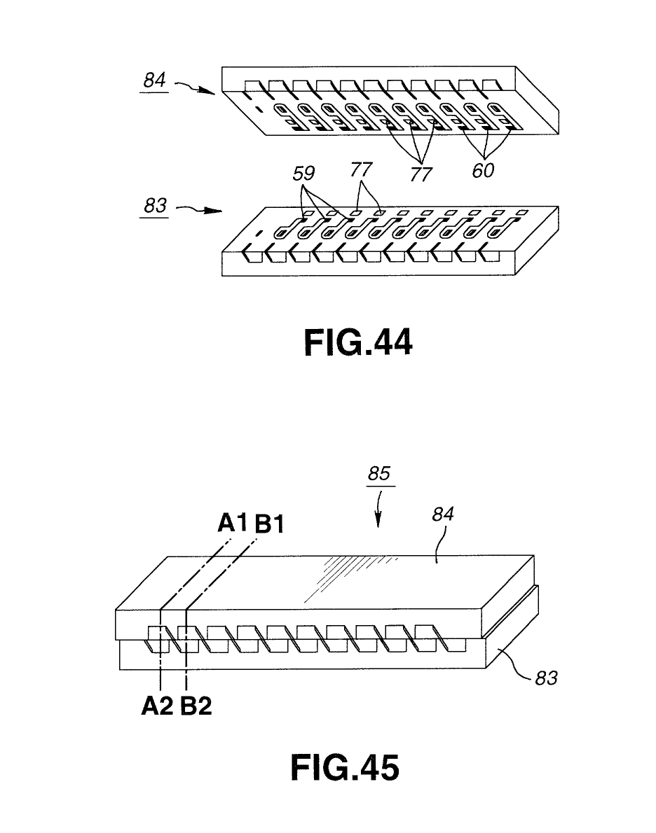

Next at the step ST14, the nonmagnetic substrates 70 and 71 are cut so that the magnetic core half blocks formed together as having been described in the foregoing are laterally laid in a row as shown in FIG. 43, resulting in a pair of magnetic core half blocks 83 and 84.

In one (83) of the pair of magnetic core half blocks 83 and 84, the conductor portion 59 is located at the side of the back gear 58 with reference to the concavity 77 while in the other magnetic core half block 84, the conductor portion 60 is located away from the back gear 58 with reference to the concavity 77.

When the pair of magnetic core half blocks 83 and 84 are butt-joined to each other, the conductor portion 59 of one of the magnetic core halfblocks (83) is opposite to the concavity 77 formed in the other magnetic core half block 84 while the conductor portion 60 of the other magnetic core half block 84 is opposite to the concavity 77 formed in the one magnetic core half block 83.

Thereafter, a joint metal layer having a predetermined shape is filmed on each of the joint faces of the pair of magnetic core half blocks 83 and 84 by sputtering or the like, which is not illustrated. The joint metal layer joins the pair of magnetic core half blocks 83 and 84 to each other by a low-temperature metal diffused junction. The layer should desirably be made of a metal such as Au, Ag, Pt, Cu, Al or the like. In this embodiment, the joint metal layer is made of Au having a thickness of about 0.1 μm.

Then, the joint metal layers of the pair of magnetic core half blocks 83 and 84 are butt-joined to each other by the low-temperature metal diffused junction to thereby join the magnetic core halfblocks 83 and 84 integrally to each other. In one of the pair of magnetic core halfblocks (83), the conductor portion 59 is fitted into the concavity 77 formed in the other magnetic core half block 84. The conductor portion 60 formed on the other magnetic core half block 84 is fitted into the concavity 77 formed in the one magnetic core half block 83.

Next at the step ST15, a magnetic core block 85 thus resulted from the function of the magnetic core half blocks 83 and 84 to each other is cut along lines A1-A2 and B1-B2 in FIG. 45 into individual bulk thin-film type magnetic heads 50 as shown in FIG. 45. At this time, the cut surfaces of the conductor portions 59 and 60 formed at the step ST13 are exposed on the head side face and serve as the connecting terminals 61 and 62 of the bulk thin-film type magnetic head 50.

The bulk thin-film type magnetic head 50 is cylindrically ground at the front end portion thereof to form the medium sliding face. The depth of the front gap 57 depends upon this cylindrical grinding.

For a good sliding contact of the medium sliding face with a magnetic recording medium, a contact restraining recess is formed in the medium sliding face to be generally parallel to the sliding direction of the magnetic recording medium. Here, the bulk thin-film type magnetic head 50 shown in FIGS. 23 and 24 is finished.

The bulk thin-film type magnetic head 50 constructed as having been described in the foregoing is attached at the surface thereof, generally parallel to the head side face on which the connecting terminals 61 and 62 are exposed, on the main surface 65a of the head base 65. The connecting terminals 61 and 62 of the bulk thin-film type head 50 are connected, with the connecting members 68 and 69, respectively, such as a wire or the like, to the pair of terminals 66 and 67, respectively, provided on the main surface 65a of the head base 65. At this time, the connecting terminals 61 and 62 of the bulk thin-film type magnetic head 50 and the terminals 66 and 67 of the head base 65, are disposed on generally parallel planes, respectively, and thus are generally parallel to one another. Therefore, these terminals can easily be connected using an automatic wiring machine such as a wire-bonding machine or the like.

The bulk thin-film type magnetic head 50 may be constructed such that the connecting terminals 61 and 62 are exposed on the joint face thereof. In this case, the connecting terminals of the bulk thin-film type magnetic head 50 may be connected directly to the terminals 66 and 67 of the head base 65, not using the connecting members 68 and 69 such as a wire or the like.

In the magnetic head according to the present invention, the connecting terminals to be connected to the terminals provided on the support base are laid on the face generally parallel to the surface of the magnetic head at which the magnetic head is joined to the support base. So, the connecting terminals can automatically be connected to the terminals on the support base using an automatic wiring machine. Therefore, the magnetic head is easy to install on the support base, and can positively be connected at the connecting terminals thereof to the terminals provided on the support base. Therefore, the magnetic head can be connected with a high reliability.

The method of manufacturing the magnetic head according to the present invention is such that the conductor portions formed on, and projected from, the joint face of one of the pair of magnetic core half blocks is cut in the direction of their thickness to be exposed on the face generally parallel to the face of the magnetic head at which the magnetic head is attached to the support base and the exposed cut surfaces of the conductor portions serve as the connecting terminals for connection to the terminals provided on the support base. Therefore, it is possible to easily manufacture a magnetic head having connecting terminals provided on a face generally parallel to a face thereof at which the magnetic head is joined to the support base. Namely, the magnetic head of the present invention can be manufactured with a considerably improved productivity.

What is claimed is:

1. A magnetic head having a pair of core blocks joined integrally to each other, and attached to a support base to write and/or read a signal into and/or from a magnetic recording medium,
at least one of the pair of magnetic core half blocks having conductor portions formed on, and projected from, a face of the one core blocks not parallel to a face at which the core block is to be attached to the support base; and
cut surfaces of the conductor portions, resulted by cutting the latter in the direction of their thickness, being exposed on a face of the magnetic core half block at which the core block is to be attached to the support base or a face of the core block generally parallel to the face at which the core block is attached to the support base, the cut surfaces serving as connecting terminals for connection to terminals provided on the support base.

2. The magnetic head as set forth in claim 1, further comprising a magnetoresistive element whose resistance varies depending upon a change of the external magnetic field and wherein the connecting terminals are electrically connected to the magnetoresistive element.

3. The magnetic head as set forth in claim 1, wherein the conductor portions are formed by allowing a conductive material to grow by plating.

4. The magnetic head as set forth in claim 1, where in the conductor portions are formed by charging a paste-like conductive material onto positions where the conductor portions are to be formed.

5. A method of manufacturing a magnetic head having a pair of core blocks joined integrally to each other, and attached to a support base to write and/or read a signal into and/or from a magnetic recording medium, comprising:
a first step at which at at least one of the pair of core blocks, conductor portions are formed on, and projected from, a face of the one core block not parallel to a face at which the core block is to be attached to the support base; and
a second step at which the conductor portions are cut in the direction of their thickness to be exposed on a face of the core block at which the magnetic core half block is to be attached to the support base or a face of the core block generally parallel to the face at which the core block is attached to the support base, the cut surfaces serving as connecting terminals for connection to terminals provided on the support base.

6. The method as set forth in claim 5, wherein the magnetic head comprises a magnetoresistive element whose resistance varies depending upon a change of the external magnetic field, and the first step is to electrically connect the conductor portions to the magnetoresistive element.

7. The method as set forth in claim 5, wherein the first step is to form the conductor portions by allowing a conductive material to grow by plating.

8. The method as set forth in claim 5, wherein the first step is to form the conductor portions by charging a paste-like conductive material onto positions where the conductor portions are to be formed.
